(19) United States
(12) Patent Application Publication
(10) Pub. No.: US 2021/0371949 A1
(43) Pub. Date: Dec. 2, 2021

(54) METHOD AND APPARATUS FOR POST WELD HEAT TREATMENT OF ALUMINIUM ALLOY COMPONENTS, AND A WELDED ALUMINIUM COMPONENT TREATED ACCORDING TO THE METHOD

(71) Applicant: NORSK HYDRO ASA, Oslo (NO)

(72) Inventors: Trond FURU, Sunndalsøra (NO); Ole Runar MYHR, Raufoss (NO)

(73) Assignee: NORSK HYDRO ASA, Oslo (NO)

(21) Appl. No.: 16/760,271

(22) PCT Filed: Oct. 29, 2018
(86) PCT No.: PCT/EP2018/079578

§ 371 Date: Apr. 29, 2020

(30) Foreign Application Priority Data
Nov. 2, 2017 (NO) 20171746

(51) Int. Cl. C21D 9/50; B23K 31/02; C22F 1/04; C21D 11/00; C21D 1/34

(52) U.S. Cl. CPC C21D 9/50; B23K 31/02; B23K 2103/10; C21D 11/00; C21D 1/34; C22F 1/04

(57) ABSTRACT

A method and an apparatus for Post Weld Heat Treatment (PWHT) of a welded aluminium alloy component and a welded aluminium alloy component treated according to the method. The welded component has initially heat affected zones with reduced load bearing capacity. The method provides that the heat affected zones are located, applying a heat source at least at one first location of said heat affected zones, where the heat source generates a temperature above Tₘᵢₙ, and where the heat source can be kept at said location for at least a period tₘᵢₙ. The apparatus contains a heat source relatively movable with regard to the component, and further being able to be positioned on defined positions thereof, the heat source further being controllable with regard to temperature and resting time that influence the heat transferred to the component at said local position.

The present invention relates to a method and apparatus for Post Weld Heat Treatment of welded aluminium alloy components and a welded aluminium alloy component treated according to the method.

The low density of aluminium alloys compared with for instance steel results in a high strength-to-weight ratio. This makes aluminium alloys attractive in many structural applications such as in the automotive industry, in marine and off-shore structures, in bridges and in buildings. However, welded aluminium alloys suffer from considerable strength reduction due to the formation of “soft zones” resulting from welding processes. This problem represents a serious limitation of the use of aluminium for structural applications since the load bearing capacity is significantly lower in the weld zone compared with the unaffected base material.

In current design standards for aluminium alloys like Eurocode 9, this strength reduction is accounted for by introducing strength reduction factors. These factors may be as low as 0.5, which means that only 50% of the base material strength can be utilised. The actual factor depends on the type of alloy and the processing conditions, Therefore, innovative solutions with regard to welding are needed for full strength utilization of aluminium for structural applications.

The present invention represents a possible solution to the strength reduction problem associated with welding. The invention can be applied for several types of welding methods, including fusion welding methods like Metal Inert Gas (MIG), Tungsten Inert GAS (TIG), Laser and Hybrid methods (e.g. Laser+MIG), Cold Metal Transfer (CMT) as well as Friction Stir Welding (FSW) methods. With the present invention is provided a new and novel method and apparatus for optimisation of load bearing capacity of welded aluminium alloy structures by local Post Weld Heat Treatment (PWHT).

The method involves Post Weld Heat Treatment of a welded aluminium alloy component with heat affected zones having reduced load bearing capacity wherein the heat affected zones are located and where a heat source is applied at least at one first location of said heat affected zones and where the heat source generates a temperature above Tₘᵢₙ, and further that the heat source is kept at said location for at least a period tₘᵢₙ.

The apparatus comprises a heat source relatively movable with regard to the aluminium alloy component, and further being able to be positioned at defined positions thereof, the heat source further being controllable with regard to temperature and resting time that influence the heat transferred to the component in said positions.

For the local heating, different methods can be used including induction heating, laser heating, electrical resistance heating, a friction stir welding tool, etc. The concept can be used for different alloys systems, including age-hardening alloys within the 4xxx, 6xxx and 7xxx series, and work hardening alloys particularly within the 5xxx system. The potential strength increase, and corresponding weight savings are particularly large for 6xxx alloys due to the high heat affected zone (HAZ) strength reduction for these types of alloys. Weight savings are not only an advantage with respect to reduced weight of the structure, but is also directly related to material costs.

Different type of aluminium product or components can be used including extruded profiles, sheet materials produced by rolling and foundry alloys and combinations of these.

By this local Post Weld Heat Treatment the load bearing capacity of the component can be increased significantly.

These and further advantages can be achieved by the invention as defined in the accompanying claims.

The invention shall be further described by examples and figures where;

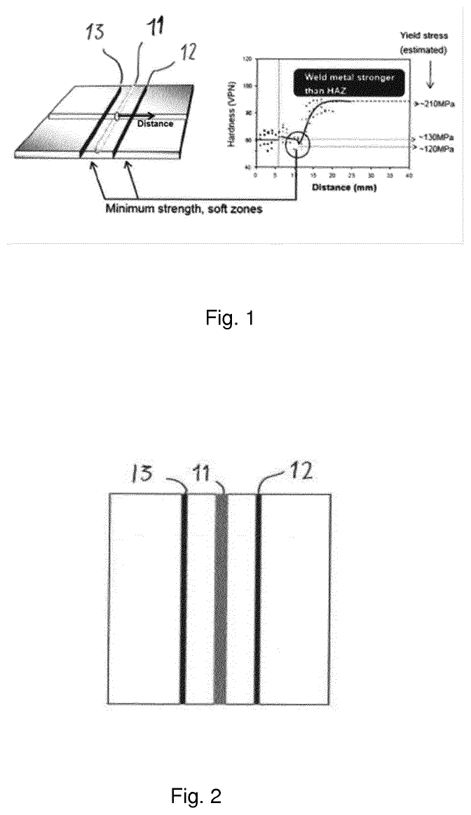

FIG. 1 illustrates results of hardness measurements across a weld for a 6060 type alloy,

FIG. 2 illustrates heat affected zones at both sides of a longitudinal weld, without local PWHT,

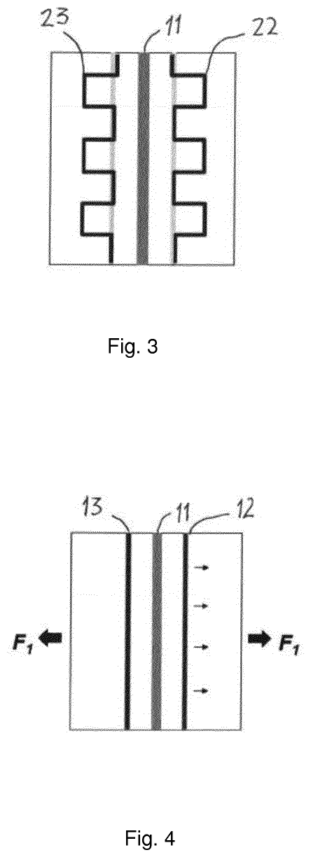

FIG. 3 illustrates heat affected zones at both sides of a longitudinal weld, after local PWHT,

FIG. 4 illustrates the load bearing capacity F₁ of the weld shown in FIG. 2,

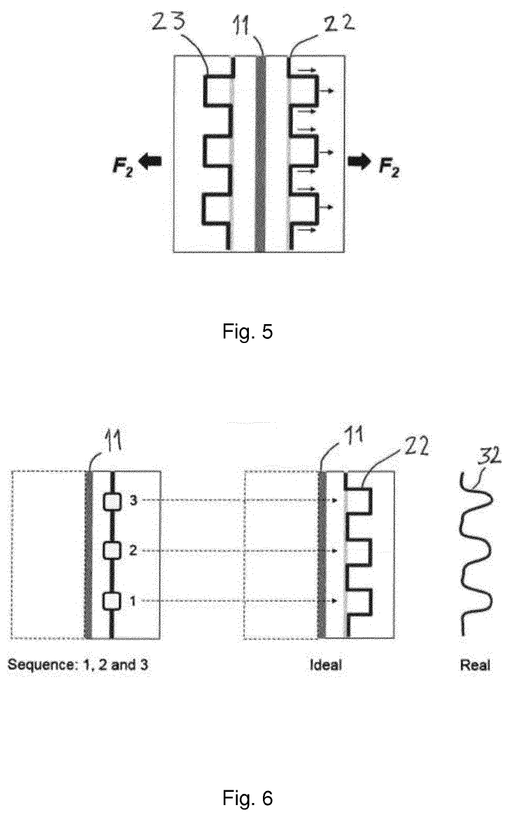

FIG. 5 illustrates the load bearing capacity F₂ of the weld shown in FIG. 3 which has been exposed to local PWHT,

FIG. 6 illustrates how the location of weak zones can be manipulated by a heat source for local PWHT,

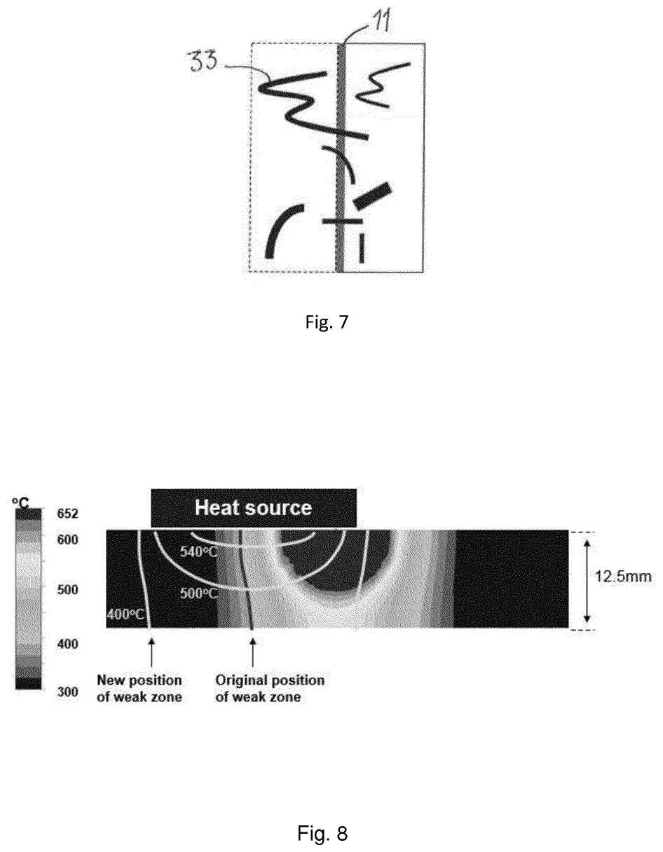

FIG. 7 illustrates a pattern along which a heat source can be moved in local PWHT,

FIG. 8 illustrates how the position of a weak zone can be manipulated in a controlled manner,

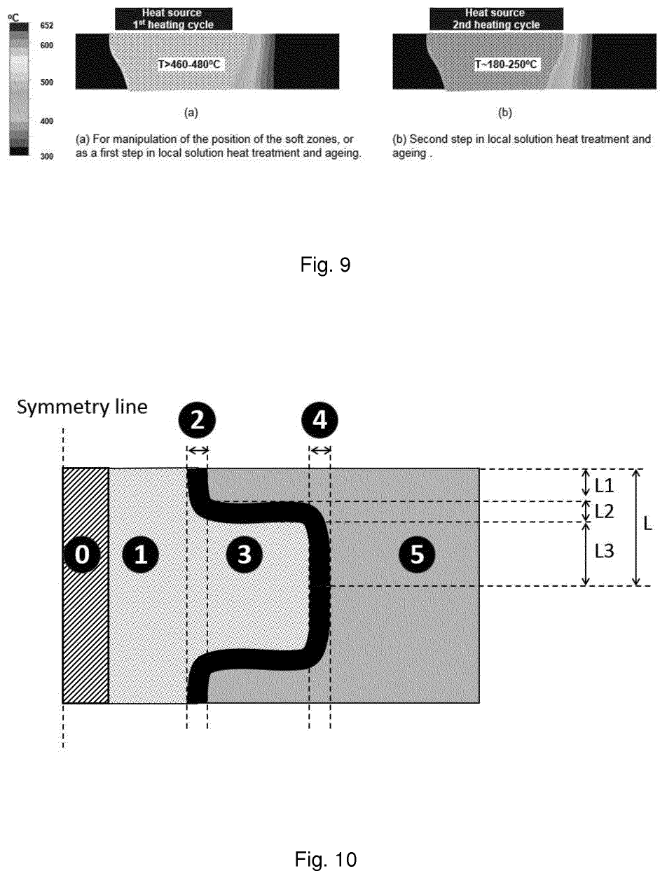

FIG. 9 illustrates using a second local heat treatment,

FIG. 10 discloses a theoretical setup for visualisation of the effect by the PWHT in accordance with the present invention,

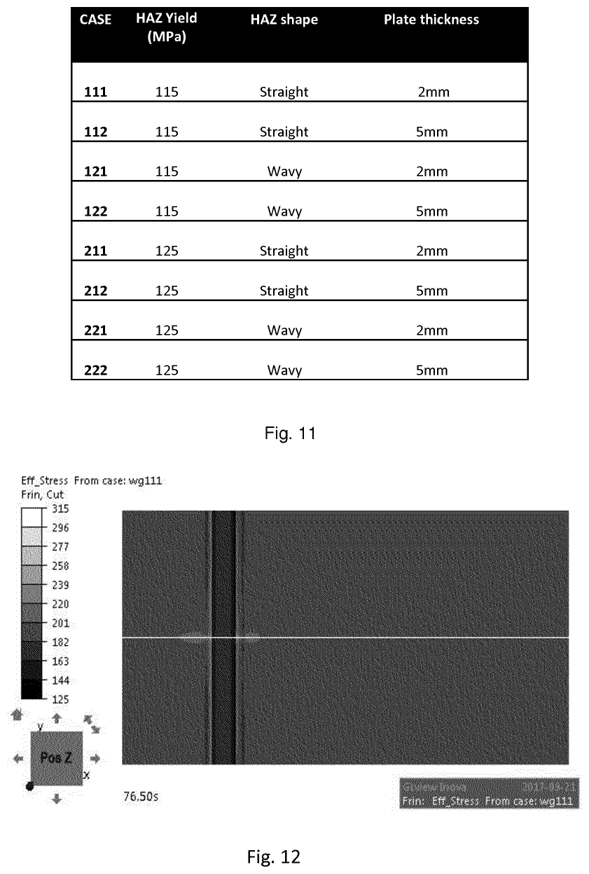

FIG. 11 discloses a verification set up of the effect of a rapid PWHT in HAZ, with straight and wavy shapes,

FIG. 12 visualizes effective stress in middle of 2 mm thick plate for 115 MPa HAZ yield stress, with a straight HAZ,

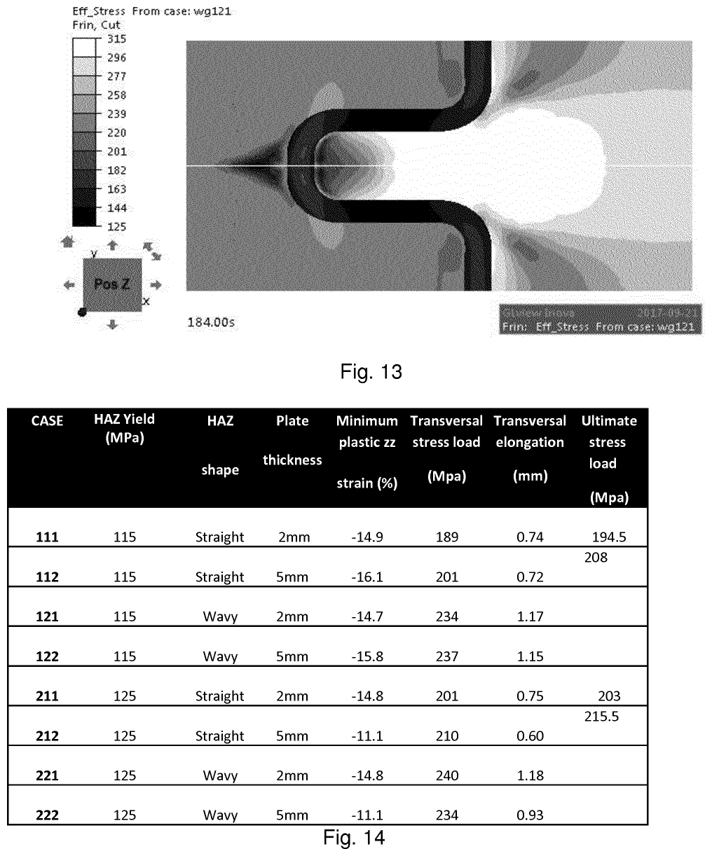

FIG. 13 visualizes effective stress in middle of 2 mm thick plate for 115 MPa HAZ yield stress, with a bulged HAZ,

FIG. 14 is a table that shows a summary of the simulation based upon the samples in FIG. 11,

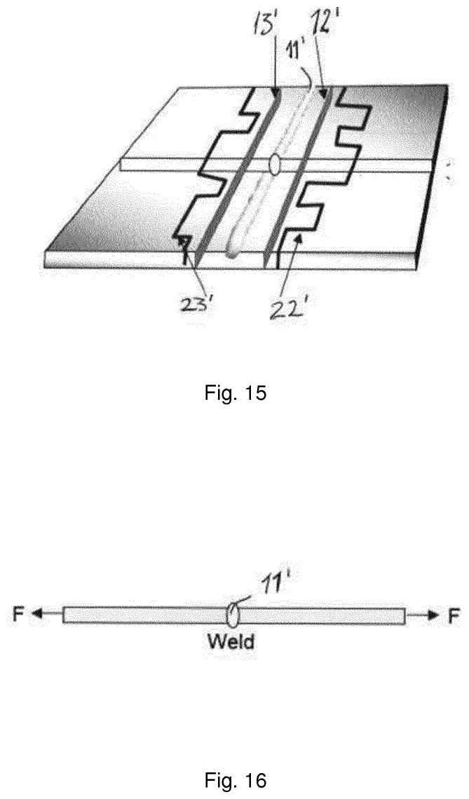

FIG. 15 discloses a further example on location of weak zones after local post heat treatment,

FIG. 16 discloses a cross section of a welded component exposed to forces in a transversal direction of the weld,

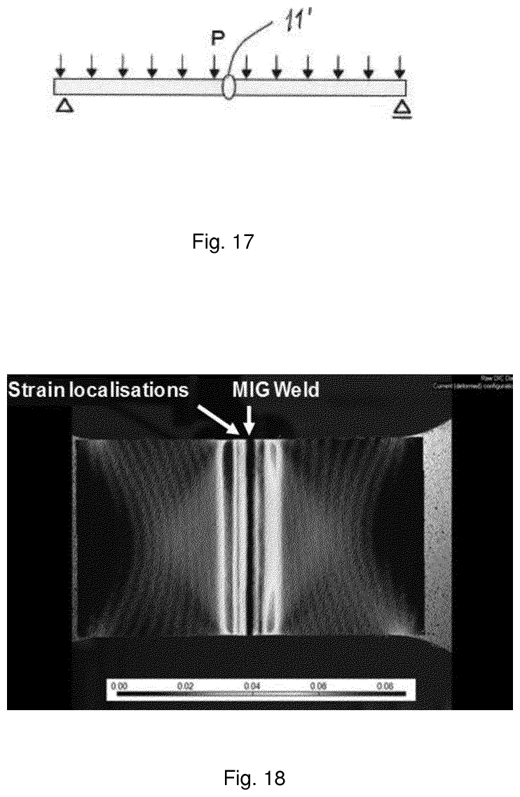

FIG. 17 discloses a cross section of a welded component exposed to pressures in a direction perpendicular to its surface,

FIG. 18 shows distribution of strains during loading transverse to weld as different greyscales, without PWHT,

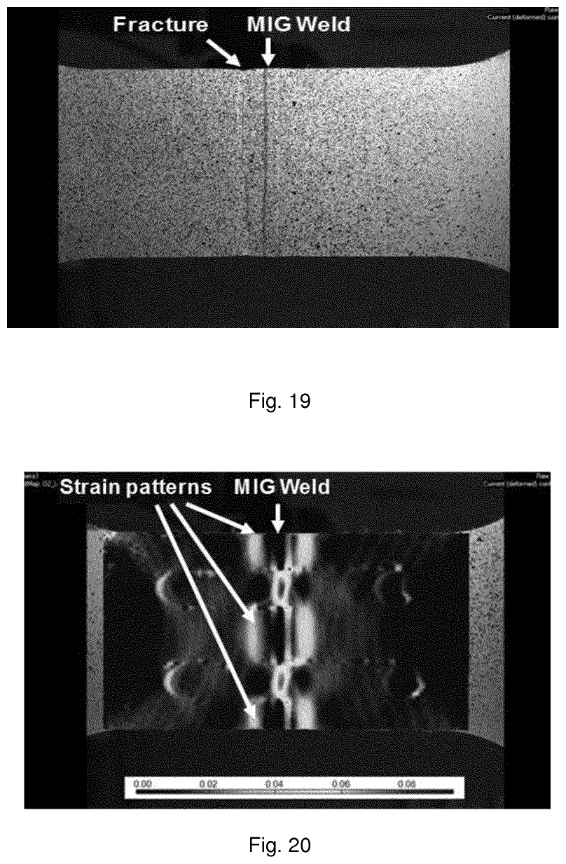

FIG. 19 shows the location of the weld of FIG. 18 and an indication of the position of fracture corresponding to the location of the soft zone in the heat affected zone, without PWHT,

FIG. 20 is similar to FIG. 18 and shows a strain pattern in grayscale, but here a local PWHT has been applied in terms of transverse heating according to the invention,

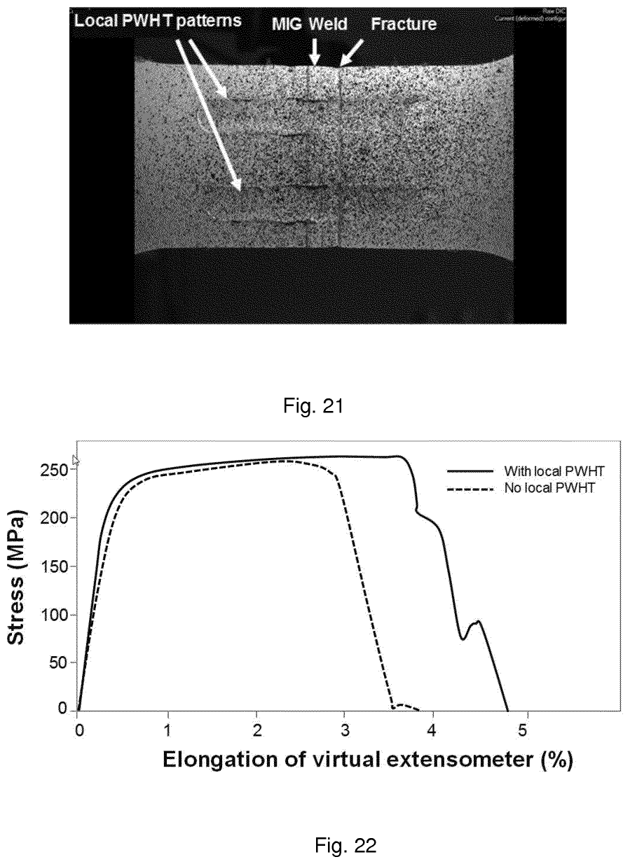

FIG. 21 shows traces of the local PWHT of FIG. 20,

FIG. 22 discloses recorded stress versus elongation for the two situations described in FIGS. 18-19 and FIGS. 20-21 respectively.

FIG. 1 illustrates results of hardness measurements across a weld 11 of a 6060 type alloy, which describes the problem to be solved by the invention. Soft zones from the weld to the borders 12, 13 in the HAZ lead to reduced load bearing capacity. Hardness measurements across the weld reveal these soft zones.

FIG. 2 illustrates heat affected zones with borders 12, 13 at both sides of a longitudinal weld 11, as shown in FIG. 1. This is a state of the art location of weak zones.

FIG. 3 illustrates location of heat affected zones at both sides of a longitudinal weld 11, after local PWHT in accordance with the present invention. Due to a selected local post weld heat treatment (PWHT), the borders of the heat affected zones 22, 23 are here illustrated as a zig-zag pattern.

FIG. 4 illustrates the load bearing capacity F₁ of the weld 11 shown in FIG. 2.

FIG. 5 illustrates the load bearing capacity F₂ of the weld 11 as shown in FIG. 3, which has been exposed to local PWHT with borders 22, 23.

It can be demonstrated that this local PWHT gives significantly higher cross-weld load bearing capacity; F₂>>F₁.

This is due to the fact that a larger area of weak zones is adapted to distribute the forces. In some regions, the weak zones are parallel to the loading direction.

The location of weak zones can be manipulated as follows; the heat source (e.g. an induction coil) is moved along a pre-defined pattern. This can be a simple pattern, for instance a straight line as illustrated in the left part of FIG. 6. In this example, the heat source first moves to position 1 and the power is turned on. Then the power is shut down, and the heat source moves to position 2, where the power again is turned on etc. This produces a new weak zone pattern, as illustrated in the right hand figures, where the real pattern 32 (outermost right) will deviate somewhat from an ideal rectangular zig-sag pattern 22. The weld is indicated by reference numeral 11.

The pattern the heat source is moving along can be complex and also perpendicular or at some angle to the weld. The pattern can also be curved shaped as illustrated in FIG. 7, see for instance reference sign 33, and they can also cross the weld 11 one or several times. It should be understood that the heat source can be turned on during movements according to this type of patterns, and can be turned off during movement between the patterns to be heat affected.

The shape (including width) and location of the patterns of the heat source, as well as the intensity (i.e. the power) which may be varying and a function of the position, can be pre-calculated by different tools, like a combination of FE-codes for calculating the weld thermal cycles, which in turn are input to physical based material models as described for instance in J. K. Holmen, T. Børvik, O. R. Myhr, H. G. Fjær, O. S. Hopperstad. International Journal of Impact Engineering, 84 (2015). pp. 96-107.

The modelling concept mentioned above can also be used in combination with optimisation tools. Superficial neural networks or similar software tools can be used to seek the optimum location, shape and power of the heat source pattern.

FIG. 8 illustrates an example how the position of a weak zone can be moved in a controlled way. It discloses a cross section normal to the welding direction. The starting point is an aluminium fusion weld deposited on a 12.5 mm thick aluminium plate. The peak temperatures are shown as regions with different grey-scales, and the corresponding temperatures are defined by the left-hand scale bar (for details: see O. R. Myhr and Ø. Grong, ASM Handbook, Volume 6A, Welding Fundamentals and Processes, Factors Influencing Heat Flow in Fusion Welding, 2011:67-81). For 6xxx-T6 aluminium alloys, the weakest zone in the HAZ is usually located close to the 400° C. isotherm, as indicated by the line (Original position of weak zone) in the Figure. By applying a heat source at the surface, with approximate position as indicated in the figure, the HAZ is reheated, and the isotherms for the maximum temperature reached during this local heat treatment are illustrated by white lines. These isotherms are rough estimates based on previous simulations on similar aluminium structures. As shown in the Figure, the white line for the 400° C. isotherm is now moved to a position further away from the weld centre line, and the weakest zone of the weld will correspond closely with this position.

It is possible not only to move and enlarge the position of the weak zones, as described above. By using a second local heat treatment following the first, artificial ageing can be obtained in regions where the temperature has exceeded about 460-480° C. in the first local heating cycle, see FIG. 9.

A complete solution heat treatment requires probably temperatures above 520° C. depending on the alloy composition and how the alloy has been processed. The initial temper condition is particularly important, and T4 condition requires a lower temperature to bring Mg and Si into solid solution compared with T6 or T7, since the hardening particles (i.e. clusters for the T4 condition) are smaller for the former temper compared with the two latter.

However, a “partial” solution heat treatment which will give some response to a second ageing cycle will take place for lower temperatures, down to about 460-480° C.

The righthand part of FIG. 9 illustrates a 2^{nd} local heating, where the temperatures are kept for some time between about 180-250° C. The yield strength will then increase significantly, depending on the actual temperature cycle in each position. The position (i.e. “pattern) that the heat source follows as well as the power applied is usually different in the 2^{nd} heating cycle compared with the first.

Starting from the heat treatment in accordance with the invention and as explained with regard to FIG. 5, it is referred to FIG. 10, which shows a top-view of one half of the welded plate, where the vertical symmetry line along the weld is shown. Here, position 0 indicates the weld metal, 1 indicates a T4 zone, position 2 and 4 indicates the outer limits of the HAZ following the weld operation and the subsequent heat treatment. A “finger” at position 3 represent a zone of the HAZ which has been heat treated to withstand loads similar to that of mentioned the T4 zone. Position 5 represents a T6 zone where load bearing properties have not been affected by the welding operation.

With reference to the lengths L1, L2, L3 and L as disclosed in the FIG. The following can be set up for the ultimate tensile strength (UTS) at positions 0-5:
0. UTS_Weld metal
1. UTS_T4
2. ((L1+L2)*UTS_HAZ+L3*UTS_T4)/L
3. (L1*UTS_T6+L2*UTS_HAZ+L3*UTS_T4)/L
4. (L1*UTS_T6+(L2+L3)*UTS_HAZ)/L
5. UTS_T6

The following numerical example shows how the relations given above can be used to estimate the effect of applying a PWHT on the resulting increase in load bearing capacity.

### Example: L=200 mm, L1=45 mm, L2=5 mm, L3=150 mm,

### UTS_T4=200 MPa, UTS_HAZ=150 MPa, UTS_T6=300 MPa

From the relations above, we get the following values for the ultimate tensile strength (UTS) for positions 1-5:
1. UTS=200 MPa
2. UTS=187.5 MPa
3. UTS=221.3 MPa
4. UTS=183.8 MPa
5. UTS=300 MPa

Hence, the minimum UTS for the component, in the present example, corresponding to the load bearing capacity, is 183.8 MPa. The corresponding load bearing capacity for a welded component that is not given any PWHT, is 150 MPa. Accordingly, the estimated increase in load bearing capacity by performing the PWHT is 22.3%.

By performing a separate heat treatment on the zone 1, it can be possible to increase the ultimate tensile strength (UTS) in this zone. Zone 1 in FIG. 9 corresponds to the soft zones in the HAZ as shown in FIG. 3, i.e. between the weld 11 and the border of the HAZ 12. By performing an optimal post weld heat treatment in this zone, the strength of the material can be improved, up to a strength similar to T6. The application of the local PWHT methodology described above can also be utilised to increase the strength in the weld metal, i.e. zone 0 in FIG. 10. The possible strength increase in the weld metal depends on the resulting chemical composition in this zone, which is given from the composition of the base material and the filler wire, respectively, and the so-called “dilution”, which defines the relative ratio of filler wire and base material in the weld metal.

The effect of a rapid PWHT treatment resulting in a significant strengthening of the zone with a complete dissolution of particles compared to the minimum strength HAZ zone has been investigated by simulations. In FIG. 11 four samples based upon 2 mm plate thickness and four samples based upon 5 mm plate thickness are given. In each of these groups there are samples with two different values of yield stress in minimum strength HAZ zones (115 MPa and 125 MPa), and further with a straight HAZ and a wavy HAZ, the latter created by local induction heating.

In FIG. 12 it is visualized effective stress in middle of 2 mm thick plate for 115 MPa HAZ yield stress, with a straight HAZ.

FIG. 13 visualizes effective stress in middle of a 2 mm. thick plate for 115 MPa HAZ yield stress, with a bulged HAZ.

Similar visualizations as that shown in FIGS. 12 and 13 have been carried out for all eight samples.

FIG. 14 discloses a summary of the simulation based upon the samples in FIG. 11. The Figure clearly illustrates that with a straight HAZ shape the transversal strength is limited by the HAZ strength, but with a wavy HAZ shape the overall load bearing capacity is strongly improved as a much higher transversal load stress must be imposed before a severe local yielding take place. The results also indicate a better energy absorption, as the transversal elongation is about 50% larger for the same value of largest local strain.

For instance, by comparison of the samples 111 and 121 both related to plates of 2 mm thickness but with straight and wavy HAZ shapes respectively, shows that the simulated transversal stress load has increased from 189 MPa to 234 MPa.

The present simulations support that the strength of a welded aluminium component can be increased by a modification of the geometric shape of the HAZ. The examples support that the shape of the remaining base material should preferably be straight narrow fingers into the softer zone rather than having a zigzag or a blunt shape. The improvement of the strength is shown to be larger when the width of HAZ to thickness of plate is larger. It is believed that the effect would be stronger if a PWHT is applied to increase the strength of the inner «T4» region.

In FIG. 15 there is shown an example on location of weak zones 22′, 23′ after local post weld heat treatment, which could be applied for different loading situations. The location of the weak zones following the welding operation is indicated at 12′, 13′. Load forces in real life can be transverse or parallel to the weld (shear forces acting in opposite directions on each of the sides of the weld 11), or a combination. Forces can also act in plane or out of plane. The forces can be distributed or act as concentrated loads.

The forces may also act due to a pressure imposed perpendicular to the surface of a component or product. In addition, this type of load can be a blast loading, that acts with a high speed on the component or product.

FIG. 16 discloses a cross section of a welded component exposed to forces in a transversal direction versus the weld 11.

FIG. 17 discloses a cross section of a welded component exposed to pressures in a perpendicular direction versus its surface. The weld is disclosed at 11′.

Experimental Verification of Concept:

FIG. 18 shows strain distribution during loading across the weld when no local PWHT has been applied. Principal stresses during loading transverse to a weld has been obtained by Digital Image Correlation (DIC) when no transverse heating (no local PWHT) has been applied.

In this experimental set up, the weld was performed by a MIG-weld, but similar stress patterns would be present by use of other welding techniques, for instance if welding is done by friction stir welding.

In the Figure, the distribution of strains is shown as different greyscales. It is evident from this Figure that strains are accumulated along two lines parallel to the weld, i.e. the white regions, which closely follows the heat affected zones (HAZ) which are located on each side of the weld. This is the normal situation during loading transverse to the weld direction when no local heating is applied, i.e. without PWHT.

FIG. 19 discloses location of the weld of FIG. 18 and an indication of the position of fracture corresponding to the location of the soft zone in the heat affected zone.

FIG. 20 discloses strain distribution during loading across the weld when local PWHT has been applied. FIG. 21 discloses the location of weld and indication of the position of the imposed local PWHT patterns. The location of the fracture is also shown.

FIGS. 20 and 21 are similar to FIGS. 18 and 19 respectively, but for the case where a local PWHT in terms of transverse heating by a friction stir source has been applied. However, for this local PWHT any appropriate heat source, such as laser, could have been applied. The resulting strain pattern shown in FIG. 20 differs significantly from the one in FIG. 18, as the strains give an almost regular pattern. FIG. 21 shows traces of the local PWHT as well as the position of the MIG weld, and also the position of the fracture.

FIG. 22 shows recorded stress versus elongation for the two different cases described in above, i.e. no application of any local heat source (broken line), and application of a local heat source transverse to the weld according to the invention (solid line).

The different strain patterns as shown in FIG. 18 and FIG. 20 give different response during transverse loading, as shown in FIG. 22. From this figure, it is evident that the sample with the local PWHT pattern gives a better overall performance than the one without. Hence, both the maximum stress as well as the elongation to fracture are better for the sample with local PWHT in accordance to the invention compared to the one without.

It should be understood that in real life the design and arrangement of the heat influenced pattern have to be optimized with regard to the actual design loads and may be different for different aluminium alloys and different combinations of multimaterial solutions.

Further, the heat source can be moved in any configuration that gives the result in accordance to the invention. For instance, it can be moved in a basic circulating pattern that can be combined with a propagating movement.

1. A method for Post Weld Heat Treatment of a welded aluminium alloy component, the weld having an extension (e) with heat affected zones of reduced load bearing capacity,
comprising the following steps:
locate the said heat affected zones,
apply a heat source at least at one first location of said heat affected zones,
where the heat source generates a temperature above Tₘᵢₙ,
and where the heat source is kept at said location for at least a period tₘᵢₙ
the heat source is removed from said first location after the lapse of period tₘᵢₙ and being applied at a second location along the extension of the weld at a predefined distance from said first location,
wherein the area of the heat affected zones is enlarged for enhanced force distribution across the weld by local Post Weld Heat Treatment.

2. The method according to claim 1,
wherein
after the lapse of period tₘᵢₙ the heat source is moved in contact with the said aluminium alloy component.

3. The method according to claim 1,
wherein
the heat source is moved in a direction transversal to the heat affected zones.

4. The method according to claim 1,
wherein
the heat source is moved in a rectangular zig-zag pattern.

5. The method according to claim 1,
wherein
the heat source is moved in accordance to pre-calculated lines and curves to form the heat affected zones (FIG. 7).

6. The method according to claim 1,
wherein
the weld is treated by local PWHT.

7. The method according to claim 1,
wherein
following the PWHT, the aluminium alloy component is heat treated in an annealing furnace.

8. An apparatus for Post Weld Heat Treatment of a welded aluminium alloy component with heat affected zones having reduced load bearing capacity, the weld having an extension (e),
comprising a heat source relatively movable with regard to the component, and further being able to be positioned on defined positions thereof along the weld, the heat source further being controllable with regard to temperature and residence time that influence the heat transferred to the component in said positions,
wherein
the heat source is further controlled in a manner where the areas of heat affected zones along the weld are stepwise enlarged for enhanced force distribution across the weld by local Post Weld Heat Treatment.

9. The apparatus according to claim 8,
wherein
the heat source is attached to a welding equipment that moves along the component.

10. The apparatus according to claim 8,
wherein
the heat source is stationary while the component is moved.

11. The apparatus according to claim 8,
wherein
the heat source is controlled by a programmable PLC.

12. The apparatus according to claim 8,
wherein
the heat source is attached to a manipulator or robot that is controlled by a programmable PLC.

13. A welded aluminium alloy component with heat affected zones treated according to the local Post Weld Heat Treatment of claim 1,
wherein
the areas of heat affected zones along the weld are stepwise enlarged by PWHT for enhanced force distribution across the weld-, thereby providing an improvement of the load bearing properties of the component.

14. The welded aluminium alloy component with heat affected zones according to claim 13,
wherein
the additional areas of heat affected zones by PWHT along the weld have an orientation different to that of the main direction of the weld.

15. The welded aluminium alloy component with heat affected zones according to claim 13,
wherein
the additional areas of heat affected zones by PWHT along the weld are oriented in such a manner that it increases the loadbearing capacity in the HAZ by improving the material's capability to withstand shear forces.

16. The welded aluminium alloy component with heat affected zones according to claim 13,
wherein
the additional areas of heat affected zones by PWHT along the weld have a zig-zag pattern.

17. The welded aluminium alloy component with heat affected zones according to claim 13,
wherein
the areas of heat affected zones along the weld by PWHT are stepwise enlarged for enhanced force distribution across the weld and are oriented in such a manner where the loadbearing capacity in the HAZ can be calculated as follows;
0. UTS_Weld metal
1. UTS_T4
2. ((L1+L2)*UTS_HAZ+L3*UTS_T4)/L
3. (L1*UTS_T6+L2*UTS_HAZ+L3*UTS_T4)/L
4. (L1*UTS_T6+(L2+L3)*UTS_HAZ)/L
5. UTS_T6
where position 0 indicates the weld metal, 1 indicates a T₄ zone, position 2 and 4 indicates the outer limits of the HAZ following the weld operation and the subsequent heat treatment, a “finger” at position 3 represent a zone of the HAZ which has been heat treated to withstand loads similar to that of mentioned the T₄ zone and position 5 represents a T6 zone where load bearing properties have not been affected by the welding operation.

18. The welded aluminium alloy component with heat affected zones according to claim 13,
wherein
the component comprises at least one of an extruded part, a rolled part or a cast part.

19. The welded aluminium alloy component with heat affected zones according to claim 13,
wherein
the component is welded to a component of a different aluminium alloy, and can be a 6082 alloy welded to a 6005 alloy.

20. The welded aluminium alloy component with heat affected zones according to claim 13,
wherein
the component is welded to a component of a metallic material other than aluminium or an aluminium alloy.

21. The welded aluminium alloy component with heat affected zones according to claim 20,
wherein
the component is welded to a steel or a steel alloy component.
